(19) United States
(12) Patent Application Publication
(10) Pub. No.: US 2026/0163641 A1
(43) Pub. Date: Jun. 11, 2026

(54) DATA ENERGY LOCALIZING COMMUNICATION SYSTEM AND METHOD THEREOF

(71) Applicant: The United States of America, as Represented by the Secretary of the Navy, Arlington, VA (US)

(72) Inventors: Don Edward Barber, Jr., Pacific Grove, CA (US); Sean Michael Kennedy, Marina, CA (US); Murali Tummala, Monterey, CA (US); John Colin McEachen, II, Carmel-by-the-Sea, CA (US)

(21) Appl. No.: 18/961,326

(22) Filed: Nov. 26, 2024

Related U.S. Application Data
(60) Provisional application No. 63/651,462, filed on May 24, 2024.

(51) Int. Cl. H04B 10/116; H04B 10/69

(52) U.S. Cl. CPC H04B 10/116; H04B 10/69

(57) ABSTRACT

A data energy localizing communication apparatus comprising: a visible light communication (VLC) transmitter, the VLC transmitter being configured to transmit an encoded data signal; and a visible light communication (VLC) receiver comprising multiple measurement areas for sensing visible light energy, the VLC receiver configured to: scan the sensed visible light energy of the multiple measurement areas for the encoded data signal; and select one or more of the multiple measurement areas for decoding the encoded data signal. Spatially isolating the transmitted signal maximizes the received signal-to-noise ratio by maximally rejecting background noise.

### CROSS-REFERENCE TO RELATED APPLICATIONS

This patent application is takes priority from U.S. Provisional Patent Application No. 63/651,462, filed on May 24, 2024, titled Improved Visible Light Communication System and Method Thereof, the contents of which are expressly incorporated herein by this reference as though set forth in their entirety and to which priority is claimed.

### STATEMENT OF GOVERNMENT INTEREST

The present disclosure was made in the performance of official duties by one or more employees of the Department of the Navy, and thus, embodiments herein may be manufactured, used or licensed by or for the Government of the United States of America for governmental purposes without the payment of any royalties thereon or therefor.

### FIELD OF USE

The present disclosure relates, in general, to a system and method of improving electromagnetic communications. More specifically, the present disclosure relates to a method and system of improving the range and data rates of a visible light communications system using signal localization to improve signal-to-noise ratio.

### BACKGROUND

Generally, visible light communication (VLC) is a wireless technology that uses visible light to transmit information. VLC systems typically use light-emitting diode (LED) transmitters to modulate the visible light used for illumination, which a photodetector or image sensor can receive. VLC systems can provide high-speed wireless data transmission and lighting simultaneously.

VLC systems may be used in advanced driver assistance systems (ADAS), such as those used in the automotive industry, to adapt or enhance vehicle systems to increase safety and provide better driving. In such systems, safety features are designed to avoid collisions and accidents by offering technologies that alert the driver to potential problems or to avoid collisions by implementing safeguards and taking over control of the vehicle.

Typically, VLC systems use photodetectors, image sensors, photodiodes, photoresistors, phototransistors, and photovoltaic light sensors. These light sensors have some disadvantages, such as short transmission coverage: VLC systems have traditionally been limited to a range of a few hundred meters, restricting them from long-distance communication because of noise and ease of being obstructed or blocked in a VLC communication channel.

The goal of a VCL system, leveraging light sources, is to improve range, robustness, and data rates. The main metric in quantifying the capability of a communication system is signal-to-noise (SNR). SNR is the ratio of signal power divided by noise power in decibel form: SNRdb=10 Log 10 SNR. Rather than measuring individual system parameters, an SNR may establish high, middle, and low SNR ratios for acceptable performance.

Intense ambient light, interference from other light sources, optoelectronic thermal energy, sensors with large detection areas, high dark currents, and capacitance can also introduce noise to a received signal. Simply increasing transmitted power does not necessarily and sufficiently improve SNR.

Previous techniques such as assuming the greatest received signal is the intended transmitted signal. This assumption could potentially lead to environmental noise being interpreted as the intended transmitted signal, leading to increased error rates in discrete systems and distorted signals in continuous systems. Broadband frequency anomaly detection of localized data sources also produced errors because of dynamic noise elements being interpreted as intended transmitted data, such as optical perturbation of high contrast areas producing stronger frequency components. Environmental oscillations from water surfaces, trees, and fans appear to modulate reflected light energy.

The potential of VLC systems and intelligent transportation systems is currently limited by the range, and data rates are limited by noise. Therefore, a method and system that improves the SNR of a received signal from an intended transmitted signal is needed.

### SUMMARY

To minimize the limitations in the prior art, and to minimize other limitations that will become apparent upon reading and understanding the present specification, the present disclosure discloses a new and useful system and method of improving visible light communications.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

The problem with noise in VLC system is solved by localizing data energy in a received signal to improve SNR.

A visual light communication (VLC) system may be a wireless technology used for communication between one or more vehicles and utilized in advanced driver assistance systems (ADAS). A VLC system may utilize lighting systems already in use to transmit data. The VLC transmitter may encode data, and the encoded data may have a frame having a preamble with an identifiable frequency. A VLC receiver may have one or more sensors having multiple measurement areas. The VLC receiver may localize sensed encoded data by identifying the identifiable frequency of the preamble and excluding all measurement areas not having an identifiable preamble frequency to improve the signal-to-noise ratio (SNR).

A data energy localizing communication apparatus comprising: a visible light communication (VLC) transmitter, the VLC transmitter being configured to transmit an encoded data signal; and a visible light communication (VLC) receiver comprising multiple measurement areas for sensing visible light energy, the VLC receiver configured to: scan the sensed visible light energy of the multiple measurement areas for the encoded data signal; and select of the multiple measurement areas for decoding the encoded data signal. A matched filter configured to maximize the signal-to-noise ratio (SNR) of the encoded data signal. The encoded data signal has a frame, and the frame has a preamble with an identifiable frequency. Whereas selection of the multiple measurement areas for decoding is based at least in part on the identification of the identifiable frequency of the preamble of the sensed visible light energy. Wherein the VLC receiver is configured to sequentially scan the multiple measurement areas. Wherein the receiver is further configured to track the movement of the selected measurement area within a volume. Wherein the VLC transmitter and the VLC receiver are configured to operate between 380 nanometers (nm) and 750 nm. Wherein the multiple measurement areas are a visible light sensor, the light sensor being selected from the group of light sensors consisting of one or more of: CMOS sensors, photodiodes, phototransistors, photomultipliers, photovoltaic cells, photoresistors, pin diodes, or CCD.

Another embodiment may be a vehicle comprising a data energy localizing communication apparatus, wherein the data energy localizing communication apparatus comprises: a transmitter, the transmitter being configured to transmits an encoded data signal; and a receiver comprising: multiple measurement areas configured to sense electromagnetic energy; the receiver being configured to scan the sensed electromagnetic energy of the multiple measurement areas for the encoded data signal and select multiple measurement areas for decoding of the encoded data signal. A matched filter configured to maximize the signal-to-noise ratio (SNR) of the encoded data signal. Wherein the encoded data signal has a frame, and the frame has a preamble with an identifiable frequency. Whereas selection of the multiple measurement areas for decoding is based at least in part on the identification of the identifiable frequency of the preamble of the sensed electromagnetic energy. Wherein scanning is the sequential measuring of the multiple measurement areas. Wherein the receiver is further configured to track the movement of the selected measurement area within a volume. Wherein the transmitter is a dual purpose visible light source. Wherein the receiver is an advanced driver assist system camera. Wherein the transmitter and the receiver are configured to operate between 380 nanometers (nm) and 750 nm. Wherein the multiple measurement areas is a visible light sensor, the light sensor being selected from the group of light sensors consisting of one or more of: CMOS sensors, photodiodes, phototransistors, photomultipliers, photovoltaic cells, photoresistors, pin diodes, or CCD.

Another embodiment may be a visible light energy localizing communication apparatus, the apparatus comprising a non-transitory computer-readable medium storing instructions executable by processors, wherein the instructions comprise instructions to increase a signal-to-noise ratio (SNR) of a visible light communication (VLC) system: A method for maximizing signal to noise ratio comprising: by a data energy localizing communication system comprising: a visible light communication (VLC) transmitter and a visible light communication (VLC) receiver; transmitting, by the VLC transmitter, an encoded data signal; wherein the encoded data signal has a frame, and the frame has a preamble with a known frequency; sensing, by multiple measurement areas of a VLC receiver sensor, energy; wherein the energy comprises the encoded data signal and noise; scanning, by the VLC receiver, the multiple measurements areas for the encoded data signal, wherein the encoded data signal is identified by the known preamble frequency in the detected energy; selecting, by the VLC receiver, multiple measurement areas for decoding; wherein the selected multiple measurement areas is based at least in part on its correlation to the preamble frequency; decoding, by the VLC receiver, the encoded data signal; and tracking, by an optical flow and image stabilization algorithm, movement of at least one of the selected multiple measurement areas within a volume; wherein the tracked measurement areas contains the encoded data signal. Multiple VLC receivers, wherein the multiple VLC receivers are configured to separately receive the encoded data signal; the method for maximizing signal to noise ratio further comprising: combining the received encoded data signal from the multiple VLC receivers, wherein a noise signal is decorrelated from the separately received encoded data signals.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of a visible light communication (VLC) system.

FIG. 2 is a flow block diagram of one embodiment of signal localization.

FIG. 3 is an illustration of a received signal on a sensor.

FIG. 4 is an illustration of one embodiment of signal localization on a passenger vehicle.

FIG. 5 is an illustration of multiple received encoded data signals being combined.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Furthermore, the one or more versions may be implemented as a method, apparatus, or article of manufacture using standard programming and/or engineering techniques to produce entirely hardware embodiment, an entirely software embodiment, or an embodiment combining software and hardware embodiments. Furthermore, the systems and methods may take the form of non-transitory computer readable media. More particularly, the present methods and systems may take the form of web-implemented computer software or a computer program product. Any suitable computer-readable storage medium may be utilized including, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick).

Those skilled in the art will recognize many modifications may be made to this configuration without departing from the scope of the disclosed embodiments.

Embodiments of the systems and methods are described below with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of the various embodiments of the device, method, and/or system. For example, as used herein, the terms “computer” and “computer system” generally refer to any device that processes information with an integrated circuit chip and/or central processing unit (CPU).

As used herein, the terms “software” and “application” refer to any set of machine-readable instructions on a machine, web interface, and/or computer system” that directs a computer's processor to perform specific steps, processes, or operations disclosed herein.

As used herein, the term “computer-readable medium” refers to any storage medium adapted to store data and/or instructions that are executable by a processor of a computer system. The computer-readable storage medium may be a computer-readable non-transitory storage medium and/or any non-transitory data storage circuitry (e.g., buggers, cache, and queues) within transceivers of transitory signals. The computer-readable storage medium may also be any tangible computer readable medium. In various embodiments, a computer readable storage medium may also be able to store data, which is able to be accessed by the processor of the computer system.

As used herein, the term “candela” refers to a unit of luminous intensity in the International System of Units (SI), defined as the luminous intensity in a given direction of a source that emits monochromatic radiation and has a radiant intensity in that same direction of 1/683 watt per steradian (unit solid angle).

As used herein, the term “signal-to-noise ratio” refers to a measure used in science and engineering that compares the desired signal level to the background noise level.

As used herein, the term “Visible light” refers to the part of the electromagnetic spectrum that humans can see having wavelengths from 380 to 750 nanometers.

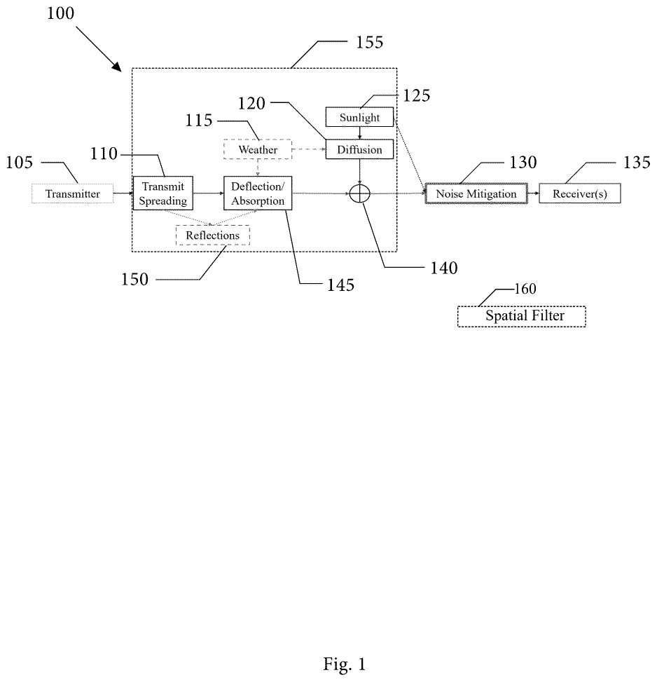

FIG. 1 is an illustration of one embodiment of a visible light communication (VLC) system. VLC communication system 100 may include transmitter 105, channel 155, and receiver 135.

VLC transmitter 105 may be but should not be limited to an electronic device that converts information (like sound, data, or video) into transmitted energy or a data signal that may be transmitted through channel 155, preferably taking a message and transforming it into a form suitable for transmission over a distance, typically using but not limited to radio waves, light pulses, or other electromagnetic signals; the primary function being to send information from one point to another. VLC transmitter 105 may utilize, but should not be limited to, light-emitting diodes (LEDs), Laser diodes, Fabry-Perot (F-P) lasers, distributed feedback (DFB) lasers, vertical-cavity surface-emitting lasers (VCSELs), and broadband light sources. LEDs may be cheaper and easier to use than laser diodes but have lower light power. Lasers may be able to transmit more light power than LEDs. Laser-based systems may be faster than LED-based systems. Broadband light sources emit light across a wide range of wavelengths and may typically be used to transmit large amounts of data. Transmitter 105 should preferably be able to modulate a light signal to represent different symbols. Modulation techniques typically vary the light signal's intensity around a positive DC value that provides lighting.

In one embodiment, VLC transmitter 155 may be a dual-use or a dual-purpose visible light source. Dual use or dual purpose may be but should not be limited to providing communications and/or light for an area.

Communicating information signals across a distance typically propagates through some form of pathway or medium. These pathways, channel 155, may use a transmission medium such as a wire, waveguide, optical guide, free space, or a logical connection over a multiplexed medium such as a telecommunications and computer networking radio channel. Channel 155 may be used for information transfer but should not be limited to continuous data signal or a digital bit stream from one or several senders to one or several receivers. Channel 155 may have a certain capacity for transmitting information, often measured by its Hz bandwidth or data rate in bits per second. Channel 155 may also comprise sources of interference or noise such as but not limited to weather 115, transmit spreading 110, deflection absorption 145, reflections 150, sunlight 125, and diffusion 120. Sources of interference or noise energy may interfere with a receiver 135 or degrade the transmitted signal, which may increase distortion and or error rates. Additional energy or light sources, such as but not limited to artificial light, sun, solar, or any other energy sources, may contribute to interference and noise.

Receiver 135 may be but should not be limited to an electronic device that receives or senses transmitted energy or data signals and converts and decodes the transmitted energy or data signal into a usable form, essentially translating the received data signal back into the original information intended by the sender, like sound, data, or video, that the intended recipient or device can understand or interpret. Receiver 135 is preferably configured to receive transmitted energy such as but not limited to radio waves, light pulses, or other electromagnetic signals, the primary function being to receive information.

In one embodiment, receiver 135 may be but should not be limited to an ADAS camera.

In some instances, interference or noise such as but not limited to weather 115, transmit spreading 110, deflection absorption 145, reflections 150, sunlight 125, and diffusion 120 may degrade or interfere with receiver 125 ability to convert or decode a signal into a usable form. Noise mitigations 130 may improve the ability of receiver 135 to convert or decode a signal and potentially improve rates and distances at which receiver 135 may operate reliably. Noise mitigations 130 may include but should not be limited to filtering, amplifying, attenuating, post-receiving signal processing, and data error correction.

Filtering of noise mitigation 130 may include but should not be limited to spatial filtering 160. Spatial filtering 160 may improve signal-to-noise ratio (SNR) in VLC and may be accomplished by limiting the field of view (FOV) and focusing a received signal onto a CMOS sensor array. Sensors (not shown) within a receiver may be one sensor, an array, or a group of sensors that may be arranged in a specific geometry, such as linear, circular, planar, cylindrical, or spherical. Each array or sensor group may have individual sensor samples or measurements. The sensors may be selected based on their individual sensing properties, such as their detection method, specificity, and molecular interaction. Individual sensors or areas for sensing, the smallest addressable element, or the smallest addressable element may be referred to as a pixel. A pixel may also be the smallest element that software can manipulate. One or more pixels, individual sensors, or areas of sensing may be areas of measurement.

In one embodiment, a sensor may be a visible light sensor such as but not limited to CMOS sensors, photodiodes, phototransistors, photomultipliers, photovoltaic cells, photoresistors, pin diodes, or CCDs. A visible light sensor may be an array that may further include micro-lenses that may concentrate light on individual photo sites. Spatial filtering 160 may be used to enhance the image based on the localization of a sensed signal on a sensor. Spatial filtering 160 may be a process that selectively ignores or removes certain portions of a received signal.

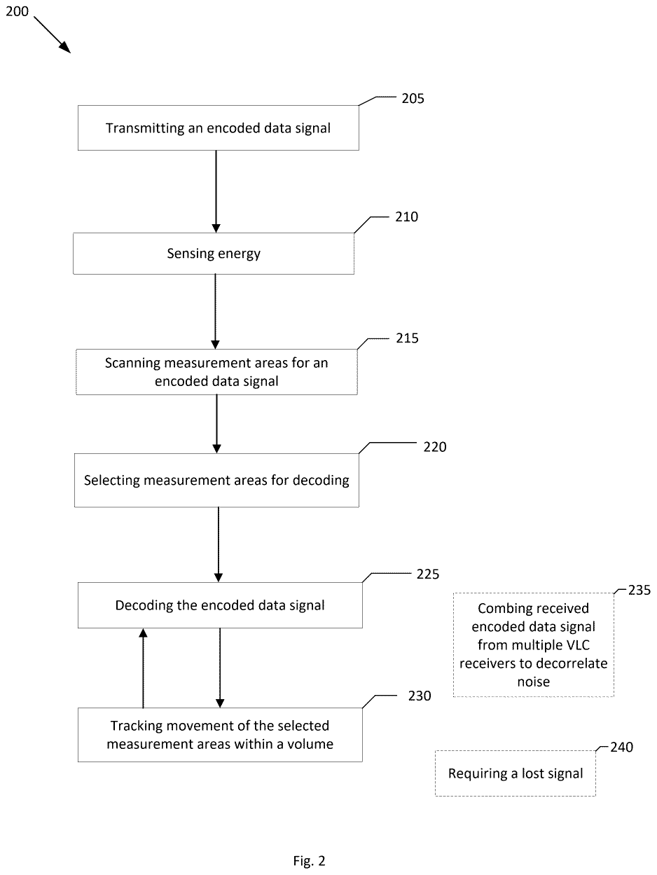

FIG. 2 is a flow block diagram of one embodiment of signal localization.

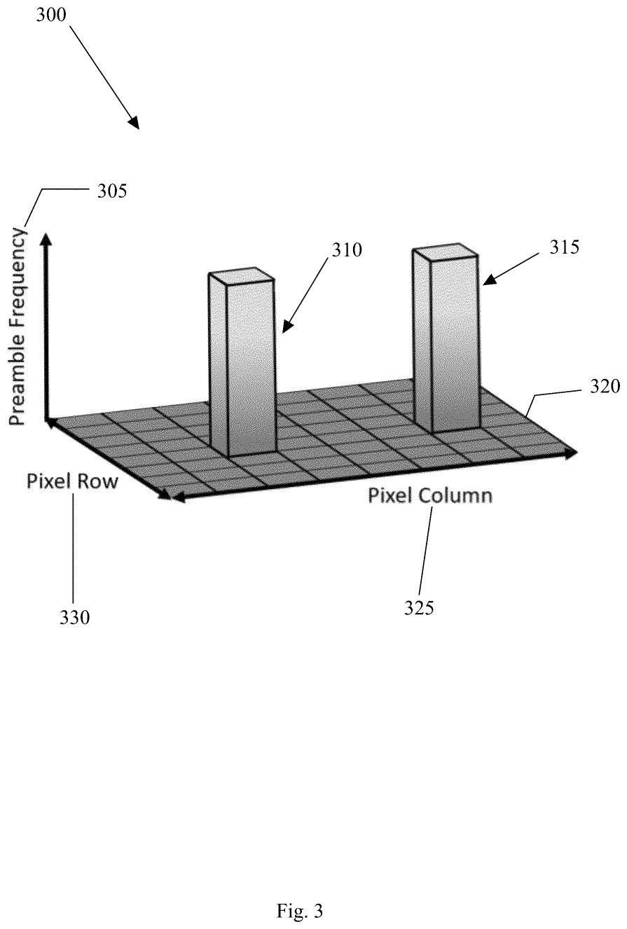

One embodiment of improving or maximizing signal-to-noise ratio (SNR) 200 may include transmitting 205 encoded data signals. Encoded data signals may further include frames with a known and identifiable preamble frequency, such as but not limited to an alternating high/low pattern in the transmitted frames that may produce an identifiable frequency. An identifiable frequency may be a specific and or distinct frequency within the frames that can be clearly recognized and separated from other frequencies, essentially pointing to a particular encoded data signal. Sensing energy 210, such as but not limited to the visible light ranging from 380 nanometers (nm) to 750 nm. Scanning 215, such as but is not limited to quickly measuring the array or group of sensors of the measurement area of a receiver for an encoded data signal. Pixels, individual sensors, or areas of sensing in an array or group of sensors may be individually measured to identify an encoded data signal. An encoded data signal may be identified by a frame, and the frame may include a preamble with an identifiable frequency. Selecting 220 pixels, individual sensors, or areas with a correlation to a known preamble for decoding. Selection 210 may be but should not be limited to overlaying the energy peak, as shown in FIG. 3, of the received image at the sensor and only selecting pixels, individual sensors, or areas containing a signal for decoding 225. Decoding 225 the encoded data signal using traditional decoding techniques. Tracking movement 230 with optical flow. Having identified the sensor region of interest containing the encoded data signal, scanning the whole imaging sensor matrix is no longer needed. Optical flow and image stabilization algorithms may be incorporated into the sensors to track movement in the scene. Shifting the position index of the selected pixels an equal distance to the shift of the overall transmitting vehicle maintains a proper selection of pixels of interest. Anchoring the signal pixels, individual sensors, or areas of interest and updating their location as the scene anchor moves. While tracking movement 230, decoding 225 may be continued.

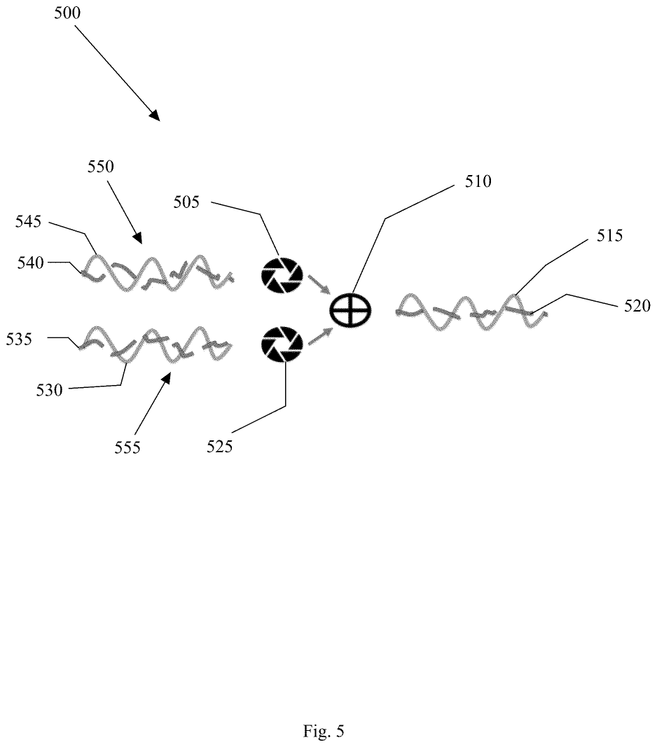

An alternative embodiment of improving or maximizing signal-to-noise ratio (SNR) 200 may include combining 235 the encoded data signal from multiple VLC receivers (as shown in FIG. 5).

In an alternative embodiment, the encoded data signal may be lost, and re-acquiring 240 a lost signal may be accomplished by sensing energy 210, scanning 215, selecting 220, Selecting 220, and tracking movement 230 may be repeated. This may allow updating the size of the area of interest as the distance between vehicles changes or atmospheric effects, such as but not limited to volumetric spreading from fog, impact the signal. If a signal is lost due to a breakdown in tracking or transmissions, full frame signal search may be resumed.

FIG. 3 is an illustration of a received signal on a sensor. Data energy localization 300 may include a received signal 310 and 315 that may be sensed energy and may include a transmitted encoded signal and noise from various sources. Sensed energy 310 and 315 may be graphically represented on an array of pixels 320. Array of pixel 320 may be further represented on a grid having a pixel column 325 and a pixel row 330. Array of pixels 320 may be arranged in a specific geometry, such as but not limited to linear, circular, planar, cylindrical, or spherical grid.

By focusing on detecting specific frequencies of the specific identifiable frequency of a preamble of an encoded data signal, a receiver may reject most other frequency content, including nearly all the noise. For example, leveraging the preamble consisting of thirty-two cycles of high and low intensity at 30 milliseconds (ms) per bit, a spectral energy scan may show sensed energy 310 and 315 pixels with large 16.667 Hz components. This technique of processing only individual pixels, rather than the whole array, requires less memory and processor cycles.

Spectral energy at the preamble frequency may be assessed at each pixel. Dot multiplying the vector containing the pixel values by sine and cosine at the preamble frequency, and the sum of the squares of the two dot products outputs may be used to capture total energy at the preamble frequency.

$$ε = {( \vec{P} \cdot \vec{C} )}^{2} + {( \vec{{P}_{x}} \cdot \vec{S} )}^{2}$$

where \vec{P}x is a vector of pixel amplitude and C and S are equal length vectors of cos (f) and sin (f) respectively, with f as the preamble frequency. The sensed energy 310 and 315 from the transmitter rises steeply above the background noise floor at the preamble frequency. Overlaying these results on an array of pixels, the sensed energy 310 and 315 may be localized.

By selecting only pixels of interest, there is an inherent aperture constraining effect, and the following SNR equation applied to the selected area of interest on the array becomes.

$$SNR = \frac{{\sum }_{px} {P}_{sig} ( px )}{{\sum }_{px} {P}_{N} ( px )} ∀ px ∈ Region of interest$$

and omitting any pixels that are just noise may increase or maximize SNR.

The inclusion of more pixels, individual sensors, or areas of sensing enables array gain for a VLC. Array gain may be defined by the relative improvement in SNR over a single pixel, individual sensors, or areas of sensing and defined by the equation:

$$G = \frac{{SNR}_{array}}{{SNR}_{sensor}}$$

Each component in the receive array could have a different weight, wn, allowing optimization based on specific filters or paths from the sensors. In RF arrays, these weights are valuable for beam forming and array optimization based on the array geometry and propagation characteristics of the field and noise. At optical frequencies, uniform weights should be considered before other optimizations based on color and polarization. Assuming all weights are unity, this provides.

$$G = \frac{{\vert {\sum }_{1}^{n} 1 \vert}^{2}}{{\sum }_{1}^{n} \vert {1}^{2} \vert} = \frac{{n}^{2}}{n} = n$$

This shows that array gain should linearly increase with additional pixels, individual sensors, areas of sensing, or additional receivers. This may translate to a noise reduction factor of 1/n in the output of a receiver. Empirical measurements showed increasing included pixels from 1 to 100 had linear gains of 2 or 3 decibels (dB). The increase in included pixels, individual sensors, or areas of sensing does not add noise, as the pixels, individual sensors, or areas of sensing containing noise should be excluded from the output of the receiver.

In another embodiment, a matched filter may be used to establish timing and maximize SNR. Using a preamble to detect timing may avoid dependencies on the encoded data. Without a preamble, an energy detector may encounter timing errors if leading data bits are zeros. Using a preamble allows both spatial and temporal localization of VLC signals.

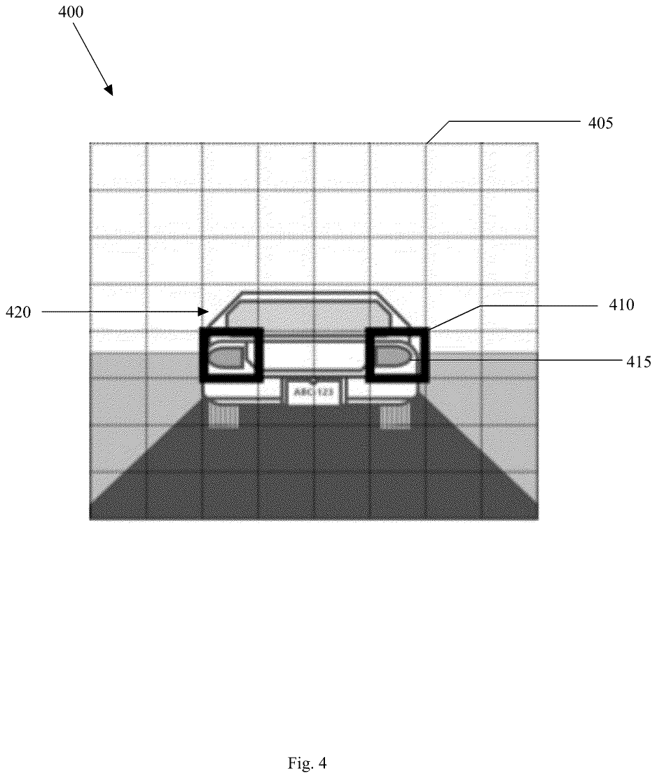

FIG. 4 is an illustration of one embodiment of signal localization on a passenger vehicle. Localizing communication system 400 may include grid 405, vehicle 420, VLC transmitter 415, and localized pixel(s) 410.

As the range increases, more of a scene can be seen by a receiver. The angle defining what is included in this cone of vision is called the angle of view, and the ultimate resulting scene is contained in the field of view (FOV). The FOV of any pixels, individual sensors, or areas of sensing may be represented by

$${P}_{FOV} = \frac{FOV}{{W}_{P}}$$

VLC transmitter 415 may be a headlight of vehicle 420. Given a known transmitter size, P_{FOV} may be manipulated to normalize.

$${Tx}_{size} = \frac{r \times sin θ}{{W}_{P}}$$

and then the number of pixels, individual sensors, or areas of sensing on receiver, as represented on grid 405 may be determined by

$${P}_{fill} = \frac{{Tx}_{size} \times {W}_{P}}{r sin θ}$$

where r is the distance from the receiver, θ is the angle of view, and W_{P} is the length of the sensor in pixels, individual sensors, or areas of sensing along the longer dimension.

The optimal localizing communication system 400 is represented by a minimal number of pixels, individual sensors, or areas of sensing to support noise mitigation or allow for tolerance for movement in a scene. The maximum supportable range may be limited by the minimum number of pixels, individual sensors, or areas of sensing represented by the following equation.

$${r}_{max} = \frac{{Tx}_{size} \times {W}_{P}}{{P}_{n} \times sin θ}$$

where Pₙ is the number of pixels, individual sensors, or areas of sensing needed in a row or column of grid 405.

FIG. 5 is an illustration of multiple received encoded data signals being combined. Localizing communication system 500 may be improved by additional receivers 505 and 525, although only two are depicted in FIG. 5, additional receivers may be implemented to improve SNR.

Multiple receivers 505 and 525 may be a means to incorporate more pixels, individual sensors, or areas of sensing for processing. Multiple separate receivers 505 and 525 may increase diversity and provide for a greater impact on SNR. Multiple receivers 505 and 525 should preferably be separated by at least the coherence distance L for the respective medium.

$$L = \frac{c}{n Δ f} \approx \frac{{λ}^{2}}{n Δ λ}$$

where n is the refractive index of the medium.

Using multiple separate receivers 505 and 525, the receiver output noise 520 at any given pixels, individual sensors, or areas of sensing may be uncorrelated, and any slight variations in external noise 535 and 540 along the different paths 550 and 550 may improve noise suppression. Averaging the multiple copies of transmitted signals 530 and 545 and multiple instances of uncorrelated external noise 535 and 545 may reduce the relative amplitude of the receiver output noise 520 while the output signal 515 remains substantially consistent. To efficiently combine 510, uncorrelated external noise 535 and 545, and transmitted signal 530 and 545, from different paths 550 and 550, transmitted signal 530 and 545 should preferably be localized in both time and space for each of separate receivers 505 and 525. Selecting pixels, individual sensors, or areas of sensing of each separate receiver 505 and 525 with the highest correlation regardless of source may generate the best SNR with the fewest pixels, individual sensors, or areas of sensing.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

Some portions of the preceding detailed descriptions have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the present disclosure, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The processes or methods depicted in the figures may be performed by processing logic that comprises hardware (e.g., circuitry, dedicated logic, etc.), firmware, software (e.g., embodied on a non-transitory computer readable medium), or a combination thereof. Although the processes or methods are described above in terms of some sequential operations, it should be appreciated that some of the operations described may be performed in a different order. Moreover, some operations may be performed in parallel rather than sequentially.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A data energy localizing communication apparatus comprising:
a visible light communication (VLC) transmitter, the VLC transmitter being configured to transmit an encoded data signal; and
a visible light communication (VLC) receiver comprising multiple measurement areas for sensing visible light energy, the VLC receiver configured to:
scan the sensed visible light energy of the multiple measurement areas for the encoded data signal; and
select one or more of the multiple measurement areas for decoding the encoded data signal.

2. The apparatus of claim 1, further comprising a matched filter configured to maximize the signal-to-noise ratio (SNR) of the encoded data signal.

3. The apparatus of claim 1, wherein the encoded data signal has a frame, and the frame has a preamble with an identifiable frequency.

4. The apparatus of claim 1, whereas selection of the multiple measurement areas for decoding is based at least in part on the identification of the identifiable frequency of the preamble of the sensed visible light energy.

5. The apparatus of claim 1, wherein the VLC receiver is configured to sequentially scan the multiple measurement areas.

6. The apparatus of claim 1, wherein the receiver is further configured to track the movement of the selected measurement area within a volume.

7. The apparatus of claim 1, wherein the VLC transmitter and the VLC receiver are configured to operate between 380 nanometers (nm) and 750 nm.

8. The apparatus of claim 1, wherein the multiple measurement areas is a visible light sensor, the light sensor being selected from the group of light sensors consisting of one or more of: CMOS sensors, photodiodes, phototransistors, photomultipliers, photovoltaic cells, photoresistors, pin diodes, or CCD.

9. A vehicle comprising a data energy localizing communication apparatus, wherein the data energy localizing communication apparatus comprises:
a transmitter, the transmitter being configured to transmits an encoded data signal; and
a receiver comprising:
multiple measurement areas configured to sense electromagnetic energy;
the receiver being configured to scan the sensed electromagnetic energy of the multiple measurement areas for the encoded data signal and select one or more of the multiple measurement areas for decoding of the encoded data signal.

10. The apparatus of claim 9, further comprising a matched filter configured to maximize the signal-to-noise ratio (SNR) of the encoded data signal.

11. The apparatus of claim 9, wherein the encoded data signal has a frame, and the frame has a preamble with an identifiable frequency.

12. The apparatus of claim 9, whereas selection of the one or more of the multiple measurement areas for decoding is based at least in part on the identification of the identifiable frequency of the preamble of the sensed electromagnetic energy.

13. The apparatus of claim 9, wherein scanning is the sequential measuring of the multiple measurement areas.

14. The apparatus of claim 9, wherein the receiver is further configured to track the movement of the selected measurement area within a volume.

15. The apparatus of claim 9, wherein the transmitter is a dual purpose visible light source.

16. The apparatus of claim 9, wherein the receiver is an advanced driver assist system camera.

17. The apparatus of claim 9, wherein the transmitter and the receiver are configured to operate between 380 nanometers (nm) and 750 nm.

18. The apparatus of claim 9, wherein the one or more of the multiple measurement areas is a visible light sensor, the light sensor being selected from the group of light sensors consisting of one or more of: CMOS sensors, photodiodes, phototransistors, photomultipliers, photovoltaic cells, photoresistors, pin diodes, or CCD.

19. A visible light energy localizing communication apparatus, the apparatus comprising a non-transitory computer-readable medium storing instructions executable by one or more processors, wherein the instructions comprise instructions to increase a signal-to-noise ratio (SNR) of a visible light communication (VLC) system:
A method for maximizing signal to noise ratio comprising:
by a data energy localizing communication system comprising: a visible light communication (VLC) transmitter and a visible light communication (VLC) receiver;
transmitting, by the VLC transmitter, an encoded data signal;
wherein the encoded data signal has a frame, and the frame has a preamble with a known frequency;
sensing, by multiple measurement areas of a VLC receiver sensor, energy;
wherein the energy comprises the encoded data signal and noise;
scanning, by the VLC receiver, the multiple measurements areas for the encoded data signal, wherein the encoded data signal is identified by the known preamble frequency in the detected energy;
selecting, by the VLC receiver, one or more of the multiple measurement areas for decoding;
wherein the selected one or more of the multiple measurement areas is based at least in part on its correlation to the preamble frequency;
decoding, by the VLC receiver, the encoded data signal; and
tracking, by an optical flow and image stabilization algorithm, movement of at least one of the selected multiple measurement areas within a volume;
wherein the tracked measurement areas contains the encoded data signal.

20. The apparatus of claim 19, further comprising multiple VLC receivers, wherein the multiple VLC receivers are configured to separately receive the encoded data signal; the method for maximizing signal to noise ratio further comprising:
combining the received encoded data signal from the multiple VLC receivers, wherein a noise signal is decorrelated from the separately received encoded data signals.
